(19) United States
(12) Patent Application Publication
(10) Pub. No.: US 2010/0009680 A1
(43) Pub. Date: Jan. 14, 2010

(54) APPARATUS AND METHOD FOR SEARCHING SERVICE BAND IN A MOBILE COMMUNICATION TERMINAL

(75) Inventor: Chang-Ho SOHN, Seongnam-si (KR)

Correspondence Address: Jefferson IP Law, LLP, 1130 Connecticut Ave., NW, Suite 420, Washington, DC, 20036, US

(73) Assignee: SAMSUNG ELECTRONICS CO. LTD., Suwon-si (KR)

(21) Appl. No.: 12/498,852

(22) Filed: Jul. 7, 2009

(30) Foreign Application Priority Data
Jul. 14, 2008 (KR) 10-2008-0068092

(51) Int. Cl. H04W 4/00

(52) U.S. Cl. 455/434

(57) ABSTRACT

An apparatus and method for service band search in a mobile communication terminal are provided. The method includes receiving system information from a Base Station (BS), extracting information identifying a band supporting a network or a service intended for access using the received system information, and searching the identified band for a service band.

### PRIORITY

This application claims the benefit under 35 U.S.C. § 119(a) of a Korean patent application filed in the Korean Intellectual Property Office on Jul. 14, 2008 and assigned Serial No. 10-2008-0068092, the entire disclosure of which is hereby incorporated by reference.

### BACKGROUND OF THE INVENTION

1. Field of the Invention

The present invention relates to an apparatus and method for searching a service band in a mobile communication terminal. More particularly, the present invention relates to an apparatus and method in which a Base Station (BS) broadcasts, through a specific channel, system information of a network, a service, a band, and the like that is provided in a corresponding country or area, and a Mobile Station (MS) quickly searches a service band using the system information.

2. Description of the Related Art

Conventional mobile communication terminals search a service band using a default band value previously stored in a volatile memory in order to perform a roaming service while using a Mobile Station (MS) outside of its service provider network. Accordingly, if the service band search succeeds using the default band value, an MS sets the default band as a service band. If the service band search fails, the MS performs a subsequent search for the entire band.

With the development of mobile communication systems, a large number of bands are produced in each country. As a result, problems occur because an MS consumes a long service band search time for band searching, roaming, and the like. Also, the long service band search time may inconvenience a user.

Therefore, a need exists for an apparatus and method for quickly searching a service band in a mobile communication terminal.

### SUMMARY OF THE INVENTION

An aspect of the present invention is to address at least the above-mentioned problems and/or disadvantages and to provide at least the advantages below. Accordingly, an aspect of the present invention is to provide an apparatus and method for service band search in a mobile communication terminal.

Another aspect of the present invention is to provide an apparatus and method in which a Base Station (BS) broadcasts, through a specific channel, system information of a network, a service, a band, and the like that is provided in a corresponding country or area, and a Mobile Station (MS) more quickly searches a service band using the system information.

According to an aspect of the present invention, a method for service band search in a mobile communication terminal is provided. The method includes receiving system information from a Base Station (BS), extracting information identifying a band supporting one of a network and a service intended for access using the received system information, and searching the identified band for a service band.

According to another aspect of the present invention, an apparatus for service band search in a mobile communication terminal is provided. The apparatus includes a storage unit for storing system information received from a Base Station (BS), and a service band searcher for extracting information identifying a band supporting one of a network and a service intended for access using the system information, and for searching the band identified in the extracted information for a service band.

Other aspects, advantages, and salient features of the invention will become apparent to those skilled in the art from the following detailed description, which, taken in conjunction with the annexed drawings, discloses exemplary embodiments of the invention.

### BRIEF DESCRIPTION OF THE DRAWINGS

The above and other objects, features and advantages of certain exemplary embodiments of the present invention will be more apparent from the following description taken in conjunction with the accompanying drawings, in which:

FIG. 1 is a block diagram illustrating an apparatus construction of a mobile communication terminal according to an exemplary embodiment of the present invention; and

FIG. 2 is a flow diagram illustrating a procedure of a method for searching a service band using system information in a mobile communication terminal according to an exemplary embodiment of the present invention.

Throughout the drawings, like reference numerals will be understood to refer to like parts, components and structures.

### DETAILED DESCRIPTION OF EXEMPLARY EMBODIMENTS

The following description with reference to the accompanying drawings is provided to assist in a comprehensive understanding of exemplary embodiments of the present invention as defined by the claims and their equivalents. It includes various specific details to assist in that understanding but these are to be regarded as merely exemplary. Accordingly, those of ordinary skill in the art will recognize that various changes and modifications of the embodiments described herein can be made without departing from the scope and spirit of the invention. Also, descriptions of well-known functions and constructions are omitted for clarity and conciseness.

The terms and words used in the following description and claims are not limited to the bibliographical meanings, but, are merely used by the inventor to enable a clear and consistent understanding of the invention. Accordingly, it should be apparent to those skilled in the art that the following description of exemplary embodiments of the present invention are provided for illustration purpose only and not for the purpose of limiting the invention as defined by the appended claims and their equivalents.

It is to be understood that the singular forms “a,” “an,” and “the” include plural referents unless the context clearly dictates otherwise. Thus, for example, reference to “a component surface” includes reference to one or more of such surfaces.

By the term “substantially” it is meant that the recited characteristic, parameter, or value need not be achieved exactly, but that deviations or variations, including for example, tolerances, measurement error, measurement accuracy limitations and other factors known to skill in the art, may occur in amounts that do not preclude the effect the characteristic was intended to provide.

A scheme in which a Base Station (BS) broadcasts, through a specific channel, system information of a network, a service, a band, and the like that is provided in a corresponding country or area, and a Mobile Station (MS) searches a service band using the system information according to exemplary embodiments of the present invention is described below.

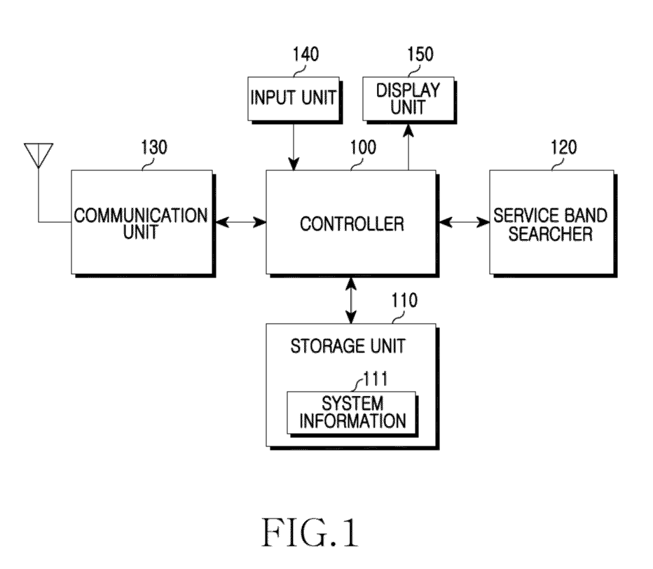

FIG. 1 is a block diagram illustrating an apparatus construction of a mobile communication terminal according to an exemplary embodiment of the present invention.

As illustrated, the mobile communication terminal includes a controller 100, a storage unit 110, a service band searcher 120, a communication unit 130, an input unit 140, and a display unit 150.

Referring to FIG. 1, the controller 100 performs control and a process for a general operation of the mobile communication terminal. More particularly, the controller 100 controls and processes a function for searching a service band using system information that is broadcasted through a specific channel from a BS. In an exemplary implementation, the BS may periodically broadcast the system information which indicates information of a network, a service, a band, and the like that is provided in a corresponding country or area.

The storage unit 110 stores a program and various kinds of information used for general operations of the mobile communication terminal. More particularly, the storage unit 110 stores the system information 111 that is broadcasted through a specific channel from a BS.

The service band searcher 120 searches a service band using system information broadcasted through a specific channel from a BS. At this time, the service band searcher 120 extracts information identifying a band supporting a network or service intended for access, and searches the identified band in a regular sequence, thus searching for the service band.

The communication unit 130 performs a role of processing a signal transmitted/received through an antenna. The input unit 140 has a plurality of function keys and provides data corresponding to a key actuated by a user to the controller 100. Also, the display unit 150 displays status information, numerals and characters generated during an operation of the mobile communication terminal.

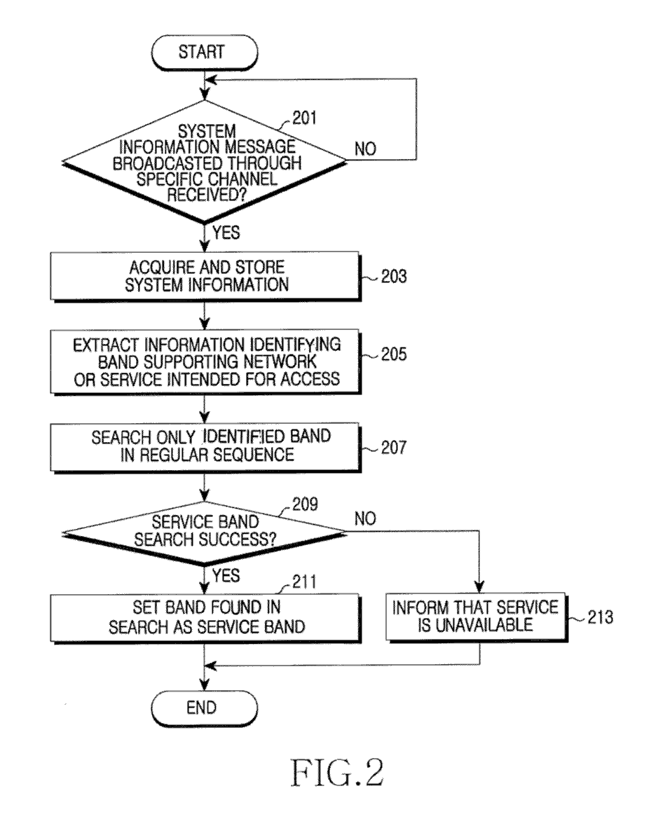

FIG. 2 is a flow diagram illustrating a procedure of a method for searching a service band using system information in a mobile communication terminal according to an exemplary embodiment of the present invention.

Referring to FIG. 2, in step 201, an MS determines if a system information message broadcasted through a specific channel from a BS is received.

If the system information message is received, in step 203, the MS acquires system information using the received system information message, and stores the acquired system information in a storage unit. Here, the system information indicates information of a network, a service, a band, and the like that a corresponding country or area provides. On the other hand, if the system information message is not received, the MS returns to step 201 and repeatedly performs the subsequent steps.

Here, the system information may be managed as a table for a support band and support service by network, by the storage unit. The table may be configured as given in Table 1 below.

TABLE 1

| Network | Band | Band | Service |
|---|---|---|---|
| WCDMA | 2100 | 900 | DMB |
| GSM | 900 | 1800 | — |

In step 205, the MS searches a band supporting a network or service that the MS itself intends to access using the stored system information, wherein the band is identified in information extracted from the system information.

In step 207, the MS searches the band for a service band in regular sequence and, in step 209, determines if the MS succeeds in the service band search. If the MS succeeds in the service band search, in step 211, the MS sets the band found in the search as a service band. If the MS fails in the service band search, in step 213, the MS outputs a signal to a display unit for informing that service is currently unavailable.

The MS then terminates the procedure.

As described above, by providing an apparatus and method in which a BS broadcasts, through a specific channel, system information of a network, a service, a band, and the like that is provided in a corresponding country or area, and an MS searches a service band using the system information, the MS may quickly access a network and service that the MS itself intends to access. That is, by searching a band supporting a network and service that an MS itself intends for access without searching the entire band, the MS may save time when first accessing the network and service. Thus, convenience in searching a service band is enhanced.

While the invention has been shown and described with reference to certain exemplary embodiments thereof, it will be understood by those skilled in the art that various changes in form and details may be made therein without departing from the spirit and scope of the invention as defined by the appended claims and their equivalents.

What is claimed is:

1. A method for service band searching in a mobile communication terminal, the method comprising:
receiving system information from a Base Station (BS);
extracting information identifying a band supporting one of a network and a service intended for access using the received system information; and
searching the identified band for a service band.

2. The method of claim 1, wherein the system information comprises information among at least one of a network, a service and a band that one of a corresponding country and a corresponding area provides.

3. The method of claim 1, wherein the system information is broadcasted through a specific channel by the BS.

4. The method of claim 1, further comprising:
if the service band search succeeds, setting the band found during the service band search as the service band; and
if the service band search fails, outputting a signal to a display unit for informing that service is currently unavailable.

5. An apparatus for service band searching in a mobile communication terminal, the apparatus comprising:
a storage unit for storing system information received from a Base Station (BS); and
a service band searcher for extracting information identifying a band supporting one of a network and a service intended for access using the system information, and for searching the band identified in the extracted information for a service band.

6. The apparatus of claim 5, wherein the system information comprises information among at least one of a network, a service and a band that one of a corresponding country and a corresponding area provides.

7. The apparatus of claim 5, wherein the system information is broadcasted through a specific channel by the BS.

8. The apparatus of claim 5, wherein, if the service band search succeeds, the service band searcher sets the band found during the service band search as the service band and, if the service band search fails, the service band searcher outputs a signal to a display unit for informing that service is currently unavailable.

9. A mobile communication system for service band searching in a mobile communication terminal, the system comprising:
a Broadcast Station (BS) for broadcasting system information through a specific channel; and
a Mobile Station (MS) for receiving the system information from the BS, for storing the received system information in a storage unit, and for searching a band supporting at least one of a network and a service that the MS intends to access using the stored system information.

10. The system of claim 9, wherein the system information comprises information among at least one of a network, a service and a band that one of a corresponding country and a corresponding area provides.

11. The system of claim 9, wherein the MS searches the band for a service band in a regular sequence.

12. The system of claim 11, wherein if the MS succeeds in the service band search, the MS sets the band found during the service band search as the service band and, if MS fails in the service band search, the MS outputs a signal to a display unit for informing that service is currently unavailable.
